(19) United States
(12) Patent Application Publication
(10) Pub. No.: US 2007/0040988 A1
(43) Pub. Date: Feb. 22, 2007

(54) Binocular glasses

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 11/208,691

(22) Filed: Aug. 22, 2005

(51) Int. Cl. G02C 7/08

(52) U.S. Cl. 351/57

(57) ABSTRACT

This present invention relates to having binocular glasses. No one has ever made hands-free easy to use binocular glasses. There is a need that we will fill with our design by providing others at sporting events, including but not limited basketball, baseball, hockey, football, racing, operas, plays, and other entertainment venues. The binocular adjusters will be on the side of the frames, you will be able to extend and retract the lenses. Some binoculars will allow you to flip down the binocular lenses onto the glasses and the adjusters will be on the side of the frames or on the front where your nose falls.

### BACKGROUND—FIELD OF INVENTION

This present invention relates to having binocular glasses. No one has ever made hands-free easy to use binocular glasses. There is a need that we will fill with our design by providing others at sporting events, including but not limited basketball, baseball, hockey, football, racing, operas, plays, and other entertainment venues.

### OBJECTS AND ADVANTAGES

Several of the advantages of my invention include:

1. Our design will enhance the design and style of all binoculars.

2. It will be lightweight and will leave your hands free so you will not have to hold the binoculars in place.

3. You will be able to wear binoculars just like regular glasses.

### SUMMARY OF INVENTION

This present invention relates to having binocular glasses. No one has ever made hands-free easy to use binocular glasses. There is a need that we will fill with our design by providing others at sporting events, including but not limited basketball, baseball, hockey, football, racing, operas, plays, and other entertainment venues. The binocular adjusters will be on the side of the frames, you will be able to extend and retract the lenses. Some binoculars will allow you to flip down the binocular lenses onto the glasses and the adjusters will be on the side of the frames or on the front where your nose falls. The binoculars will be used to view portable cell phone television screens. They will be used to view portable video game screens. There is a need where viewing cell phone screens are hard and people are tired. The screen is too small and we will magnify it with our binocular glasses and it will not harm your eyes.

### BRIEF DESCRIPTION OF DRAWINGS

FIG. 1 displays the binocular glasses from the front view without the flip down feature. FIG. 1-100 is the retractable and extendable adjuster on the side.

FIG. 2 displays another front view of the binocular glasses. Instead of having adjusters on the side of the frames, it is located on the front above where your nose sits. FIG. 2-100 represents the adjusters for the binocular glasses.

FIG. 3 shows the binocular glasses from the side view. FIG. 3-100 is the adjuster located on the side frames of the binocular glasses, which gives the wearer easy use to retract and extract lenses. FIG. 3-200 shows the binocular extended to see thing from a father distance.

FIG. 4 displays the binocular glasses from the side view after the lenses have been extended. FIG. 4-100 shows the adjusters and how they extend. FIG. 4-200 show why the binocular glasses are extended.

FIG. 5 show the binocular glasses from the side view before the lenses have been extended. FIG. 5-100 shows the adjusters and how the lenses look when they have been retracted.

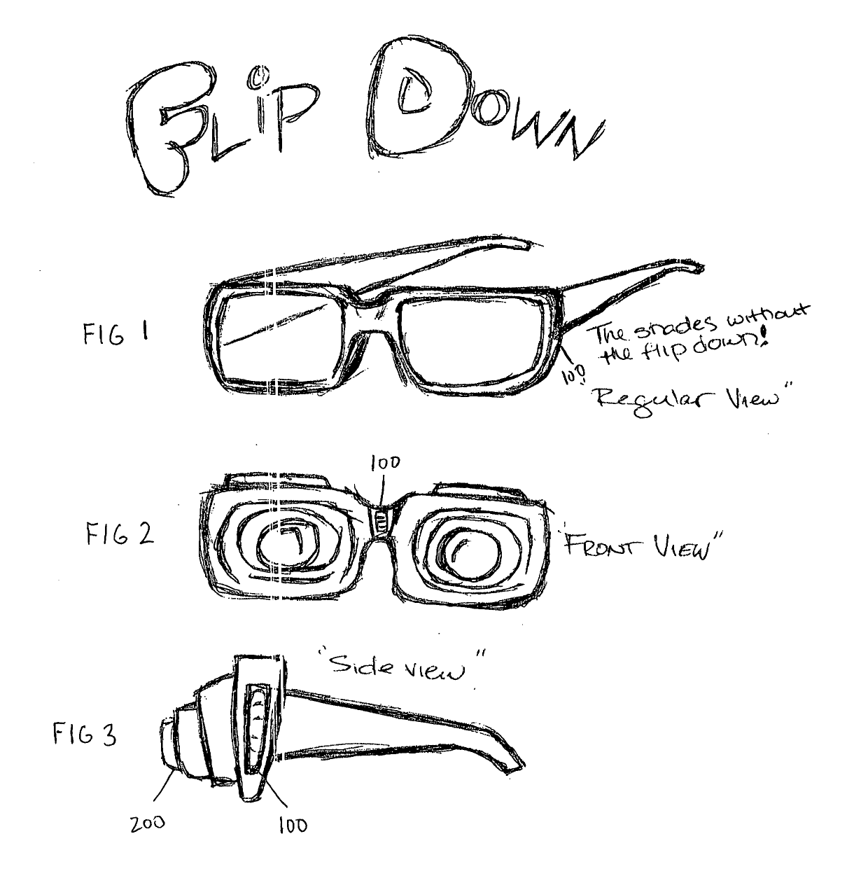

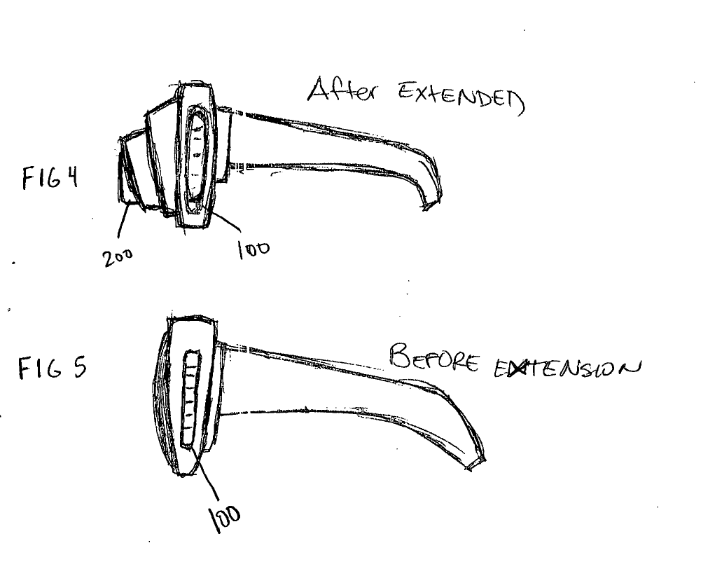

### DETAILED DESCRIPTIONS OF DRAWINGS

This present invention relates to having binocular glasses. No one has ever made hands-free easy to use binocular glasses. There is a need that we will fill with our design by providing others at sporting events, including but not limited basketball, baseball, hockey, football, racing, operas, plays, and other entertainment venues. The binocular adjusters will be on the side of the frames, you will be able to extend and retract the lenses. Some binoculars will allow you to flip down the binocular lenses onto the glasses and the adjusters will be on the side of the frames or on the front where your nose falls. You will be able to leave your hands free, unless you need to adjust the binoculars. They look great and have style. To adjust the glasses you will need to scroll down and up depending if you want to extend or retract the lenses. The glasses will come in different colors and maybe with a team's logo and/or colors on them.

What I claim as my invention is:

1. A method of creating binocular glasses that are hands free.

2. The method of claim 1 where the binocular adjusters will be located on the sides of the frames of the glasses.

3. The method of claim 1 where the binocular adjusters will be located on the front of the binocular glasses above where your nose sits.

4. The method of claim 1 where the binoculars will flip down over the glasses.

5. The method of claim 1 where the binoculars will be in front of the glasses.

6. The method of claim 1 where the binoculars will be in front of the glasses and the adjusters will be located on the side of the frames of the glasses.

7. The method of claim 1 where the binoculars will flip down over the glasses and the adjusters will be located on the side of the frames of the glasses.

8. The method of claim 1 where the binoculars will be in front of the glasses and the adjusters will be located on the front of the binocular glasses where your nose fits.

9. The method of claim 1 where the binoculars will flip down over the glasses and the adjusters will be located on the front of the binocular glasses where your nose fits.

10. A binocular comprising a focus operating means to adjust the state of an image.

11. The schematic design from claim 10 where there is a control means for adjusting the focus of an object.

12. The method of claim 1 where the binoculars will be used to view portable cell phone television screens.

13. The method of claim 1 where the binoculars will be used to view portable video game screens.

14. The use of any binocular glasses used to magnify portable cell phone screen used for television and portable video game screens.
